(19) United States
(12) Patent Application Publication
(10) Pub. No.: US 2019/0188794 A1
(43) Pub. Date: Jun. 20, 2019

(54) COMPUTER PROCESSING OF STATE USING KEY STATES

(71) Applicant: TSX INC., Norval (CA)

(72) Inventors: Andre Di GENOVA, Norval (CA); Charles FRANTOWSKI, Mississauga (CA)

(21) Appl. No.: 16/326,111

(22) PCT Filed: Aug. 18, 2017
(86) PCT No.: PCT/IB2017/055015

§ 371 Date: Feb. 15, 2019

Related U.S. Application Data
(60) Provisional application No. 62/376,845, filed on Aug. 18, 2016.

(51) Int. Cl. G06Q 40/04; G06F 16/903; G06F 16/901; G06F 16/904

(52) U.S. Cl. CPC G06Q 40/04; G06F 16/904; G06F 16/901; G06F 16/903

(57) ABSTRACT

A system for providing order book state includes an exchange data interface to receive order data from an electronic exchange system. The order data is representative of orders at the electronic exchange system for an instrument. The system further includes a converter to convert order data into order event data by applying any rule used by the exchange system to execute the orders and instructions to compile the order event data into computed order books. Each computed order book is a representation of an actual order book for the instrument at the exchange system at a respective time. The system further includes an analyst interface to output representations of the computed order books.

### CROSS-REFERENCE TO RELATED APPLICATIONS

This application claims priority to U.S. provisional patent application 62/376,845, filed Aug. 18, 2016, the entirety of which is incorporated herein by reference.

### FIELD

This disclosure relates to computer systems and more specifically computer systems for processing state information.

### BACKGROUND

Processing large quantities of data for analysis and other purposes requires a suitably large amount of processing and storage resources. When the data itself includes processing instructions, the time and resources required are increased. For example, in the financial industry, recreating an order book for an instrument often requires processing orders for the instrument, as the orders often contain both data (e.g., price) and instructions (e.g., limit order, stop order, cancel, etc.). It is prohibitively computationally intensive to recreate order books in this way to meet the demands of market data analysis.

### SUMMARY

According to one aspect of this disclosure, a method for generating order book state includes obtaining order data representative of an order at an electronic exchange system for an instrument and converting the order data into order event data, including applying any rule used by the exchange system for executing the order. The order event data includes price, side, and quantity information. The method further includes compiling the order event data into a key order book that is a representation of an order book for the instrument at the exchange system and storing the order event data and the key order book for subsequent access.

According to another aspect of this disclosure, a method for querying order book state includes receiving a query, the query including an indication of a specified time for which an order book for an instrument of an electronic exchange system is to be provided. The method further includes obtaining from a key order book database a key order book having a representative time that is within a threshold of the specified time, obtaining an intervening order event that is temporally inclusively between the representative time of the key order book and the specified time, compiling order event data of the intervening order event into the key order book to obtain a resultant key order book, and outputting the resultant key order book as a representation of the order book for the instrument at the specified time.

According to another aspect of this disclosure, a system for providing order book state includes an exchange data interface to receive order data from an electronic exchange system. The order data is representative of orders at the electronic exchange system for an instrument. The system further includes a converter to convert order data into order event data by applying any rule used by the exchange system to execute the orders and instructions to compile the order event data into computed order books. Each computed order book is a representation of an actual order book for the instrument at the exchange system at a respective time. The system further includes an analyst interface to output representations of the computed order books.

### BRIEF DESCRIPTION OF THE DRAWINGS

FIG. 1 is a diagram of a computer system.

FIG. 2 is a diagram of an example data structure for an order.

FIG. 3 is a diagram of an example data structure for a trade.

FIG. 4 is a diagram of an example data structure for an order event.

FIG. 5 is a diagram of an example data structure for an order book.

FIG. 6 is a diagram of an example state system.

FIG. 7 is a flowchart of an example compilation process for processing and storing order events.

FIG. 8 is a flowchart of a process for a query to obtain order book state.

FIG. 9 is a snippet of source code to apply an order event to an order book to obtain a computed order book.

### DETAILED DESCRIPTION

This disclosure relates to computing a representation of a state with reference to a previously computed key state and differential information. This may be used to efficiently generate a representation of an order book for a financial instrument at arbitrary points in time. Such a representation of an order book may not be identical to the actual order book at the exchange at the same time, but may be sufficiently accurate to facilitate analysis. This may provide for efficient processing and analyzing of the order book in real-time or near real-time, while allowing fast random access to any state of the order book.

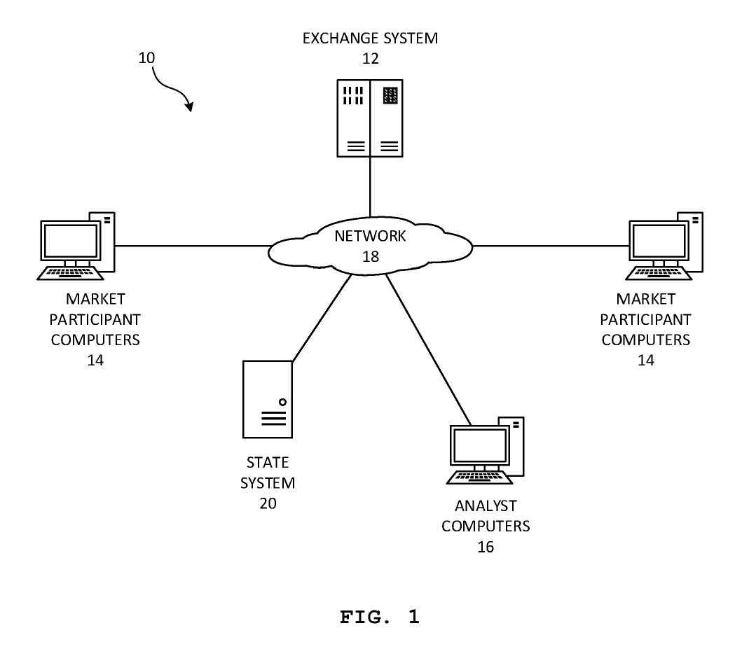

FIG. 1 shows a computer system 10. The system 10 includes an electronic exchange system 12, market participant computers 14, analyst computers 16, a network 18, and a state system 20. The system 10 allows for storing and viewing of cumulative market state of a financial instrument in the form of an order book at any specified time.

The exchange system 12 includes one or more computers, which may be termed servers, that implement the electronic trading of financial instruments, such as stocks, bonds, funds, and the like. The exchange system 12 may be termed an electronic stock exchange, an electronic exchange, a stock market, an electronic market, or similar.

The market participant computers 14, which may include any number of servers, terminals, and client computers, are operated by market participants, such as traders, dealers, and similar. The market participant computers 14 initiate trades with the exchange system 12 by sending orders to the exchange system 12.

The analyst computers 16 which may include any number of servers, terminals, and client computers, may be operated by market participants, market analysts, and other interested parties. There may be overlap between the analyst computers 16 and the market participant computers 14, and any given computer may be both an analyst computer and a market participant computer.

The network 18 includes any one or more computer networks to facilitate data communications among the exchange system 12, the market participant computers 14, the analyst computers 16, and the state system 20. The network 18 may include a local-area network (LAN), a wide-area network (WAN), a wireless network, an intranet, a virtual private network (VPN), the interne, and similar.

The state system 20 includes one or more computers, which may be termed servers, that provide market state data based on the operations of the exchange system 12. Analyst computers 16 connect to the state system 20 to retrieve such data. The state system 20 obtains or is provided data relevant to orders for one or more instruments at the exchange system 12 and computes order book state based on such data.

FIG. 2 shows an example data structure 30 for an electronic order that may be provided to the exchange system 12 by a market participant computer 14 for execution. The order data structure 30 may include data fields indicating venue, symbol, order type, side, price, quantity, attribute, similar, order ID, sequence number, and similar. Venue may identify the exchange at which the order is to be executed. Symbol may uniquely identify the specific financial instrument to be bought or sold. Order ID and sequence number uniquely identify orders and their relative sequence. Sequence number may be used to arrange orders in the order they were received by the exchange system. Time typically cannot be used for this, as it may be possible for multiple order actions to take place within the same short duration, such as on the order of a millisecond. Order timestamps often fail to have sufficient granularity. Order type may indicate a market order, limit order, stop order, stop-limit order, day order, open order, or similar. Side indicates the position, such as buy or sell. Price indicates the relevant price, which may be a limit price or similar. Quantity indicates the desired amount of the instrument to be traded. Attribute may indicate one or more rules, conditions, or other data relevant to the type of order. For example, an attribute may be used to prevent self-trades. Another example attribute may be used to indicate that the order should be canceled if it cannot be filled completely. There may be overlap between order type and attribute. Some exchanges may use order type to distinguish two different kinds of orders, while other exchanges may use attributes to do the same.

The exchange system 12 processes orders, such as those defined by data structure 30, to execute trades. One order may result in zero, one, or more trades.

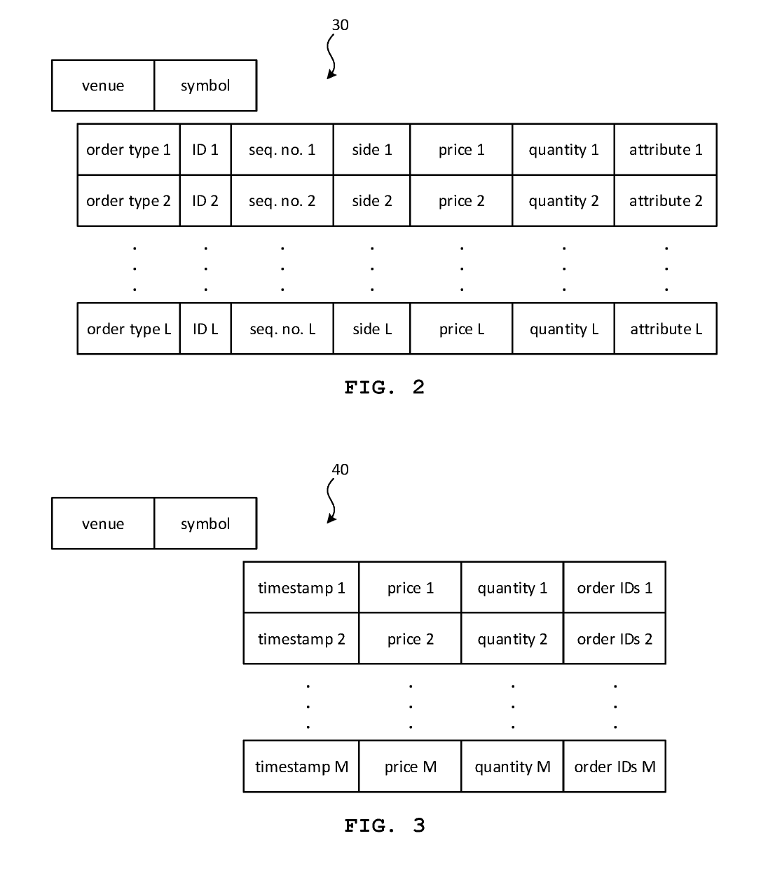

FIG. 3 shows an example data structure 40 the represents an electronic trade that may have been executed by the exchange system 12. The trade data structure 40 may include data fields indicating venue and symbol to identify the instrument, as well as the time of the trade, the price at which the trade was executed, the quantity or volume for the trade, and identification or data of the constituent orders that made the trade. Constituent order identifiers uniquely identify the orders that interacted. Constituent order data may include identifiers of the buyer and seller and similar data and may the source of price and quantity data.

The potentially vast quantity of orders and trades make the data structures 30, 40 and their related processes impractical for quickly and efficiently analyzing market data, particularly if the state of an order book is to be presented for random access. There may be thousands or millions of orders per day for a given symbol, and tens of millions or more across an exchange system. There are often more orders than trades, as two orders are required for a trade and many orders are canceled before they trade. Processing such amount of data for analysis in a reasonable amount of time to obtain order book state requires a very large amount of processing and memory resources.

FIG. 4 shows an example data structure 50 for an order event, with a sequence of example order events numbered 1 to N being illustrated. The order event data structure 50 can be used to compute order book state at any given time, while reducing memory and processing requirements to do so. The order event data structure 50 may be used by the state system 20 to store order events.

The data structure 50 may specify venue and symbol for each order event or for a sequence of order events. Each order event 52 in an order event sequence may include an event envelope 54, sequence number or timestamp 56, and instrument order payload parameters 58. Envelope 54 may store arbitrary metadata, such as event type, for example, an indication of an order being either created, amended, or canceled. Timestamp or sequence number 56 may be taken as a primary key that determines the temporal ordering of order events 52 in the sequence. For example, for an order event E of a sequence S, the timestamp of an order event in sequence S immediately previous to order event E is less than or equal to the timestamp of the order event E, and the timestamp of an order event in sequence S immediately after order event E is greater than or equal to the timestamp of order event E. Further, any order event E of sequence S and order event Y of sequence S, such that the timestamp of order event E is less than or equal to the timestamp of order event Y, can form an order event subsequence S_{EY} of sequence S represented by the order events temporally in-order between, from and including, order event E to and including order event Y such that subsequence S_{EY} is also an order event sequence.

Parameters 58 may specify side (e.g., buy or sell), quantity, and price. Quantity indicates a differential change to the order book at a particular price. The sense of the differential change (positive or negative) may be indicated by the side parameter.

The order event data structure 50 may be used to store changes, which may be termed deltas, to an order book. Data stored in the order event data structure 50 is different from data stored by the order data structure 30 and the trade data structure 40. Orders stored by the order data structure 30 are subject to an exchange's business rules and may result in any number of trades, including no trades. Trades stored by the trade data structure 40 represent actual trades that have taken place, which do not reflect the state of the order book. The state system 20 may use the order event data structure 50 to construct an empirical representation of an order book, at any point in time.

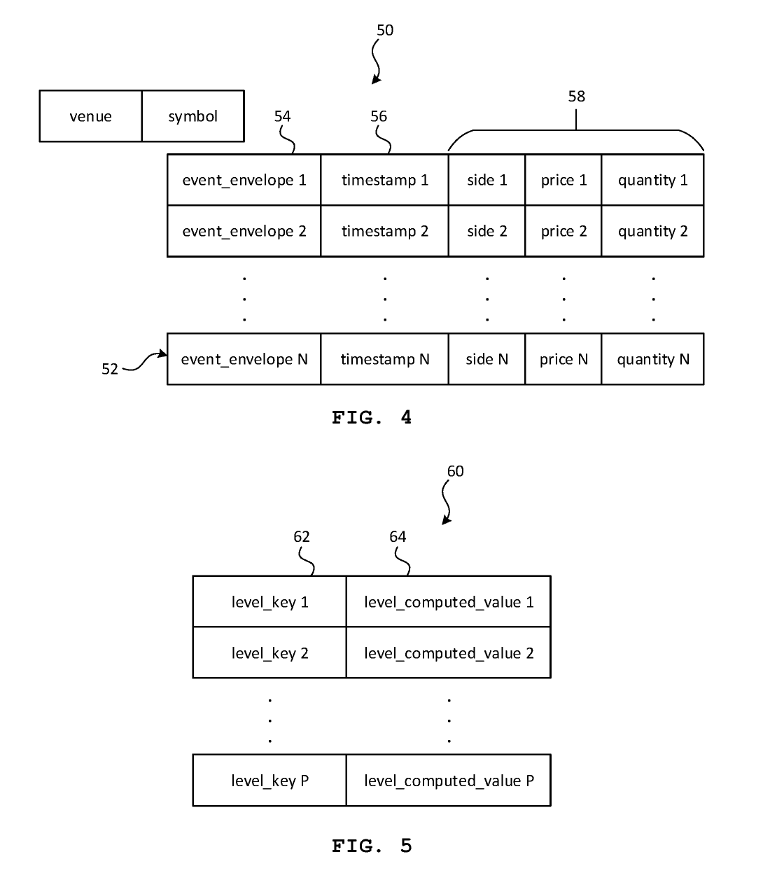

With reference to FIG. 5, an example data structure 60 for a key order book is shown. The state system 20 may use the key order book data structure 60 to store key, or snapshot, states of an order book. A key order book includes any number, P, of key-value pairs for order book levels, such as price. Each key-value pair contains a key 62 and a computed value 64. A key order book may be computed based on an input order event sequence U. Summation of order event data from the sequence U, in temporally forwards or backwards order, may be performed. During summation, key-value pairs may be created, modified, and deleted. Each key order book has an order book representative time, which may be taken as equal to the timestamp value of the temporally final order event of the order event sequence U. A key order book may thus be considered snapshot of an order book at a particular instant in time. For example, for a particular instant in time, a key order book may be generated with price levels as keys 62 and quantities/volumes as computed values 64. A price level key 62 need only be created when there is an associated quantity, and a price level key 62 may be deleted when an existing quantity is deleted. Generating such a key order book may include summing data from a sequence of order events up to the particular time. Summing forwards in time may include, for each price level, counting sell-side quantities as positive and counting buy-side quantities as negative. Summing backwards in time may use inverse signs (sell side is negative and buy side is positive).

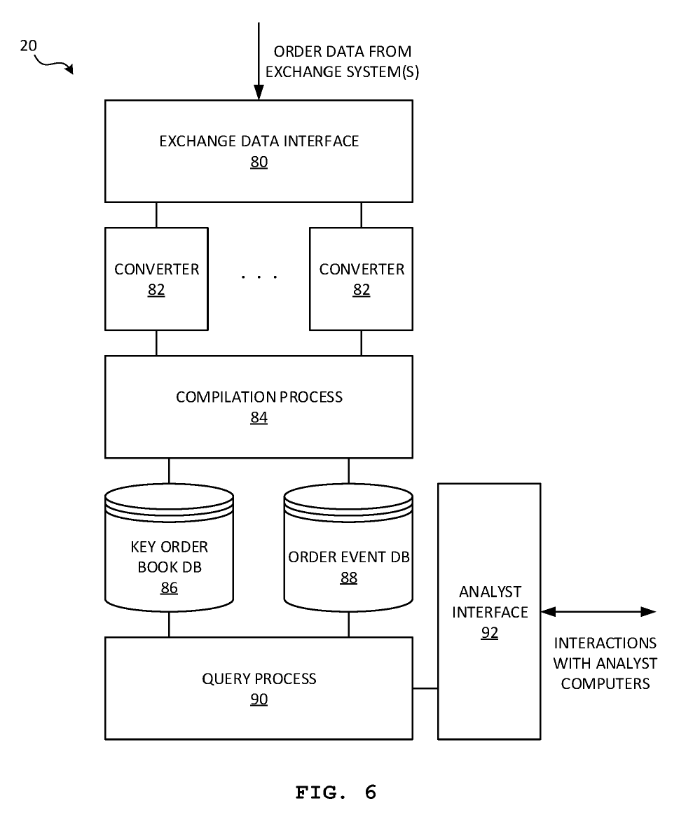

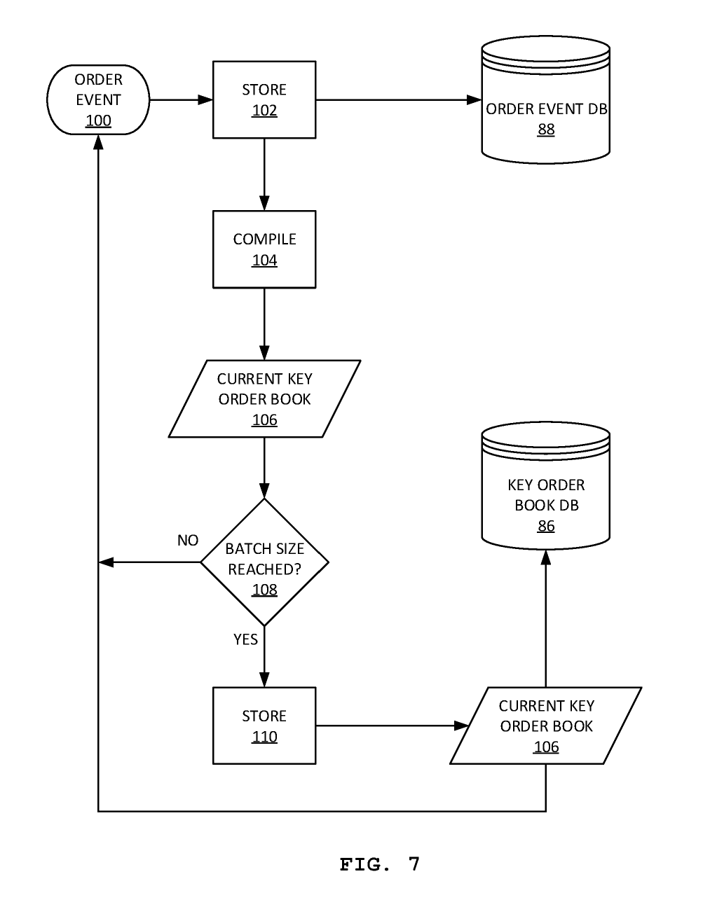

FIG. 6 shows a diagram of an example state system 20. The state system 20 may be implemented by one or more computers, which may be termed server, that include one or more processors and memory. The state system may be implemented by instructions that are stored in a non-transient computer readable medium, such as computer memory, and executable by a processor. The state system 20 may be contained on one machine or may be distributed across a computer network on several machines.

The state system 20 includes an exchange data interface 80, one or more converters 82, a compilation process 84, a key order book database 86, an order event database 88, a query process 90, and an analyst interface 92.

The exchange data interface 80 is to connect with data sources, such as any number of exchange systems 12. The exchange data interface 80 receives order data from the exchange systems 12. Such order data accords with an order data structure, such as the order data structure 30 shown in FIG. 2.

A converter 82 is connected to the exchange data interface 80 and is configured to convert order data from an order data structure to an order event data structure, such as the order event data structure 50 shown in FIG. 4. Due to varying types and formats of orders, several converters 82 may be used. In one example, a converter 82 is provided for each exchange system 12. The converter 82 may include instructions to apply the respective exchange system's 12 business rules to order data receive from that system 12 to obtain sequenced order event data. That is, the converter 82 executes the exchange's rules for limit orders, stop orders, and the like to distill actual order data into order event data representative of an empirical change to the order book.

The compilation process 84 is defined by instructions to receive order event data from the converter 82 and store such data in the order event database 88. The compilation process 84 also generates key order books from order events and stores key order books in the key order book database 86. The compilation process 84 thus builds a readily accessible order-book dataset. An example of a compilation process 84 is discussed with respect to FIG. 7.

The analyst interface 92 provides a user interface, such as a Web interface or smartphone/tablet app interface, to analyst computers. A graphical user interface (GUI) may be provided. The analyst interface 92 may be configured to generate graphs, tables, charts, or other data visualization based on results returned by the query process 90 for output at analyst computers. This allows processing of interactions with the analyst computers to provide order book data and representations to the analyst computers.

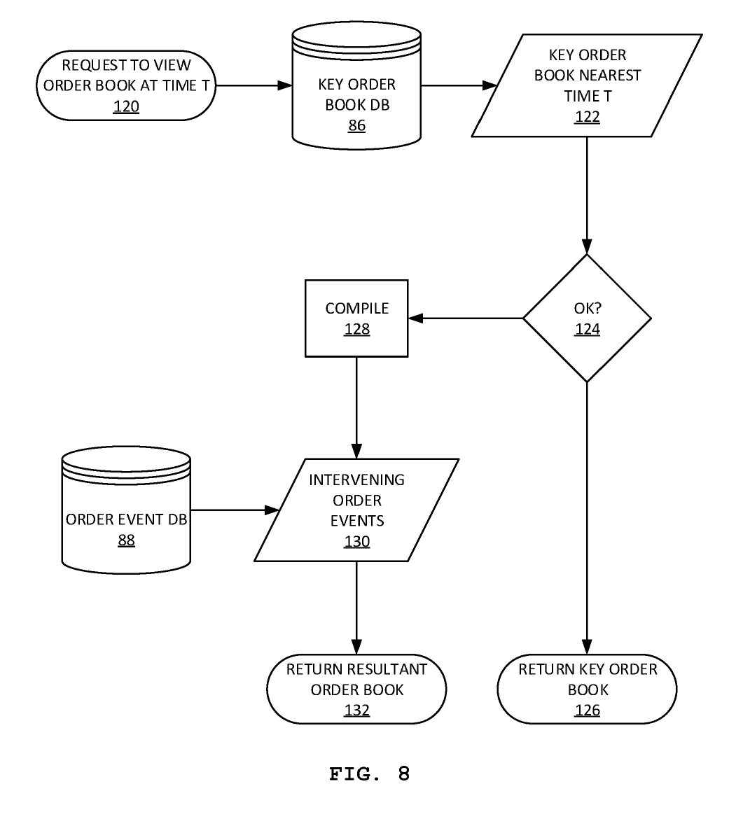

The query process 90 is defined by instructions to receive interaction commands from the analyst interface 92, process the relevant key order book(s) and order event data, and output order book data and representations thereof to the analyst interface 92 for transmission to the relevant analyst computers. For example, should an analyst computer request a chart of an order book at a particular time during a trading day, the query process 90 searches the key order book database 86 for a temporally close or the closest key order book, modifies the key order book using any order events having timestamps between the particular time and the timestamp or representative time of the retrieved key order book, and returns the modified key order book to the analyst interface 92 as a representation of the actual order book for generation of the chart. An example of a query process is discussed with respect to FIG. 8.

The state system 20 may implement an extract, transform, load (ETL) process to realize some or all of the above functions. The state system 20 may use clustered computation techniques and distributed database technology, such as Presto (www.prestodb.io).

With reference to FIG. 7, an example order event compilation process is shown. Order data from an exchange system are processed into order events, and each order event 100 is stored 102 in an order event database 88. Order events are collected into order event sequences of specified size, which may be referred to as batches. A current order event 100 is compiled 104 with a current batch, which represents a current or instantaneous key order book 106. Once the batch size is reached 108, the instantaneous key order book 106 is stored 110 in the key order book database 86 and used as the initial starting point for the next batch. Compiling 104 may include, for example, adding a quantity of the current order event 100 to a quantity at the same price level of the instantaneous key order book 106, with sell-side quantities being positive and buy-side quantities being negative, as compilation occurs over normal flow of time. If the price level of the order event 100 is not present in the instantaneous key order book 106, then that price level may be created. If a quantity for a price level in the instantaneous key order book 106 becomes zero, then that price level may be deleted. The order event database 88 and key order book database 86 are output products of this process.

The order event compilation process may be triggered by an order hitting the book of an exchange system 12 or by the amendment to an already booked order. A state system 20 that implements the order event compilation process may receive data of such an order and, in response, convert the order data into an order event 100 then trigger execution of the order event compilation process on the order event 100. The state system 20 may obtain order data using any technique, such as polling a data feed of the exchange system 12 or having the exchange system 12 actively transmit order data without prior request by the state system 20.

The batch size test 108 represents the distance between key order books, or order book snapshots. Such distance is not constant in time and depends on the frequency of order events.

With reference to FIG. 8, the order book query process starts with a request 120 to view an order book at a specified time T. A key order book 122 near time T is obtained from the key order book database 86. Strictly speaking, the key order book 122 need not be the nearest key order book to time T. However, the closer the key order book 122 is to time T, the less computation is needed. If the retrieved key order book 122 is within a threshold 124 of the specified time T, the key order book 122 may be returned as the result 126. The threshold may be an exact match of the specified time T to the timestamp or representative time of the key order book 122. The threshold may be a duration that is insignificant to analysis, such as 1 millisecond. That is, if the key order book 122 is close enough to the requested time T, then it is considered to be the result and no further computation is required. If the retrieved key order book's representative time contravenes the threshold, then data from relevant order events are compiled 128 into the key order book 122. Any order events 130 that occurred between the specified time T and the representative time of the key order book 122, inclusively, are retrieved from the order event database 88. Order event data of these one or more intervening order events 130, such as quantity, is summed with like data of the key order book 122 to generate a resultant order book 132 that is representative of the cumulative market state at specified time T. The resultant order book 132 is returned as the result and may be saved as a new key order book for future use.

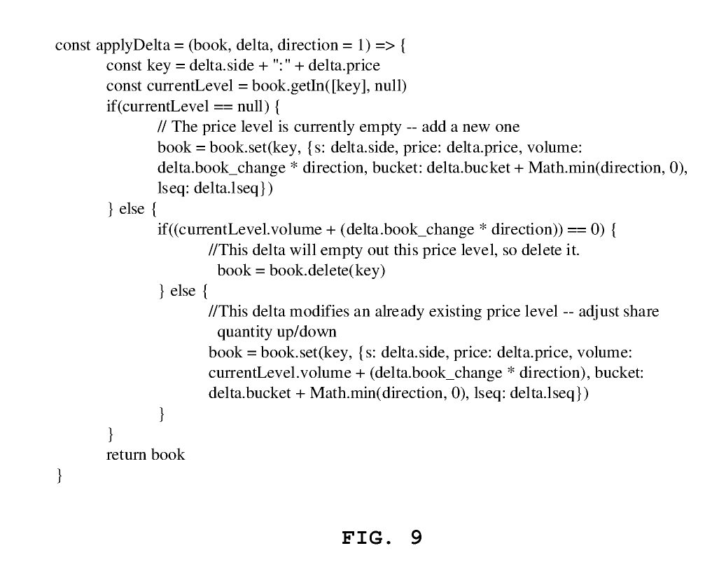

FIG. 9 shows a snippet of source code to apply an order event to an order book to obtain another order book that is keyed by, for example, side and price. This code can be used by the compilation process to generate key order books from a sequence of order events. This code can also be used by the query process to generate arbitrary order books from a nearby key order book and one or more order events. For example, this code can be used to implement bocks 104 and 128 of these processes.

“Delta” is a single order event that is to be applied to an order “book”, which is an existing key order book, in the case of the query process, or an instantaneous order book, in the case of the compilation process. A blank order book is used if starting from a predetermined datum time (e.g., 12:00 AM). The bucket variable is an identifier of a bucket to which the order event (delta) belongs. The bucket variable may be considered analogous to a timestamp of the order event or delta. This may simplify the data by collapsing many deltas in to bigger chunks that represent, for example, 10 millisecond time windows. “Direction” represents the temporal direction of the computation. If it is desired to compute an order state snapshot that is temporally earlier than the order book, the direction would be set to “−1”. To compute an order book that is temporally after the order book, the direction would be set to “1”.

It is possible that orders are received and processed by an electronic exchange system 12 at a rate that is not humanly perceptible. For example, a multitude of small orders (e.g., 20) may arrive at the electronic exchange system 12 within a very small time window (e.g., 10 milliseconds). Accordingly, order event data may be summed before generating key order books. That is, one element of order event data may be based on several orders. Information of each of individual order would be lost. However, this may be useful for analyses where differentiation between such orders is not necessary.

In view of the above, it should be apparent that computing reference states, such as key order books, and modifying such by delta information, such as order events, as needed reduces the amount of resources required to perform analysis and further reduces latency when accessing arbitrary state. Moreover, the output of the techniques discussed herein is neither exchange-dependent order data, which may contain embedded instructions, nor simple trade data. Rather, the output is a sequence of order book states, which is similar in structure to other types of data in other domains. Hence, known analysis tools can be readily applied.

It should be recognized that features and aspects of the various examples provided above can be combined into further examples that also fall within the scope of the present disclosure.

We claim:

1. A method for generating order book state, the method comprising:
obtaining order data representative of an order at an electronic exchange system for an instrument;
converting the order data into order event data, including applying any rule used by the exchange system for executing the order, the order event data including price, side, and quantity information;
compiling the order event data into a key order book that is a representation of an order book for the instrument at the exchange system; and
storing the order event data and the key order book for subsequent access.

2. The method of claim 1, further comprising compiling order event data of a batch of order events into the key order book.

3. The method of claim 2, further comprising taking the key order book as an initial key order book for compilation with order event data of a next batch of order events.

4. The method of claim 1, wherein the compiling comprises summing a quantity in the order event data with a quantity in the key order book at a same price.

5. The method of claim 4, wherein the summing uses a positive value of the quantity when the order event data indicates a sell side, and wherein the summing uses a negative value of the quantity when the order event data indicates a buy side.

6. A method for querying order book state, the method comprising:
receiving a query, the query including an indication of a specified time for which an order book for an instrument of an electronic exchange system is to be provided;
obtaining from a key order book database a key order book having a representative time that is within a threshold of the specified time;
obtaining an intervening order event that is temporally inclusively between the representative time of the key order book and the specified time;
compiling order event data of the intervening order event into the key order book to obtain a resultant key order book; and
outputting the resultant key order book as a representation of the order book for the instrument at the specified time.

7. The method of claim 6, further comprising compiling order event data of more than one intervening order events into the key order book to obtain a resultant key order book.

8. The method of claim 6, wherein the threshold specifies the representative time to be equal to the specified time.

9. The method of claim 6, wherein the compiling comprises summing a quantity in the order event data with a quantity in the key order book at a same price.

10. The method of claim 9, wherein the summing uses a positive value of the quantity when the order event data indicates a sell side, and wherein the summing uses a negative value of the quantity when the order event data indicates a buy side.

11. A system for providing order book state, the system comprising:
an exchange data interface to receive order data from an electronic exchange system, the order data representative of orders at the electronic exchange system for an instrument;
a converter to convert order data into order event data by applying any rule used by the exchange system to execute the orders;
instructions to compile the order event data into computed order books, each computed order book being a representation of an actual order book for the instrument at the exchange system at a respective time; and
an analyst interface to output representations of the computed order books.

12. The system of claim 11, further comprising instructions to compile and store computed order books in response to receiving order data and converting order data into order event data.

13. The system of claim 11, further comprising instructions to retrieve computed order books and compile order event data into the retrieved computed order books in response to receiving requests at the analyst interface.

14. The system of claim 11, further comprising a database to store the order event data.

15. The system of claim 11, further comprising a database to store the computed order books.

16. The system of claim 11, wherein the analyst interface comprises a graphical user interface.
